(19) United States
(12) Patent Application Publication
(10) Pub. No.: US 2024/0326630 A1
(43) Pub. Date: Oct. 3, 2024

(54) POWER MANAGEMENT SYSTEM AND ELECTRIC VEHICLE

(71) Applicant: TOYOTA JIDOSHA KABUSHIKI KAISHA, Aichi-ken (JP)

(72) Inventors: Mitsuaki TOMITA, Aichi-ken (JP); Osamu YUMITA, Aichi-ken (JP); Sa KANO, Aichi-ken (JP); Naoki HASEGAWA, Aichi-ken (JP); Takuji MATSUBARA, Aichi-ken (JP)

(21) Appl. No.: 18/619,161

(22) Filed: Mar. 28, 2024

(30) Foreign Application Priority Data
Mar. 30, 2023 (JP) 2023-055416

(51) Int. Cl. B60L 53/63; B60L 53/14; H02J 7/04

(52) U.S. Cl. CPC B60L 53/63; B60L 53/14; H02J 7/04

(57) ABSTRACT

A power management system manages an exchange of electric power between power storage devices of a plurality of electric vehicles which respectively transport a cargo at least in a facility, and a charging and discharging device connected to an electric power system of the facility. The power management system includes a vehicle management device. The vehicle management device is configured to select the electric vehicle with surplus capacity for a discharge from the power storage device based on SOC of the power storage device of each of the electric vehicles and the weight of the cargo of each of the electric vehicles when an electric power supply from at least one of the electric vehicles to the electric power system is requested. Further, the vehicle management device is configured to instruct the selected electric vehicle to discharge from the power storage device to the electric power system.

### CROSS-REFERENCE TO RELATED APPLICATION

The present disclosure claims priority to Japanese Patent Application No. 2023-055416 filed, Mar. 30, 2023, which is incorporated herein by reference in its entirety including specification, drawings and claims.

### TECHNICAL FIELD

The present disclosure relates to a power management system that manages an exchange of electric power between power storage devices of an electric vehicle that transports a cargo, and a charging and discharging device connected to an electric power system of a facility. Further, the present disclosure relates to the electric vehicle that transports the cargo at least in the facility.

### BACKGROUND

A conventionally known energy management apparatus includes a remaining amount receiving module that acquires the remaining amount of a battery installed in an aircraft and a planning module that prepares an electric power usage plan, which is a plan for using electric power in an airport based on the remaining amount of the battery of the aircraft (see, for example, Patent Literature 1). The planning module of the energy management device prepares an operation plan for electric vehicles used for work in the airport based on the electric power usage plan. Further, the planning module selects the electric vehicle to be charged with electric power from the battery of the aircraft or another charging device based on a distance between the electric vehicle and the aircraft parking apron, SOC of a battery of the electric vehicle, working hours, and the like.

### CITATION LIST

### Patent Literature

[Patent Literature] Japanese Patent Application Laid-Open No. 2022-045029

### SUMMARY

Here, when the battery of the electric vehicle is connected to the electric power system of the airport via a charging and discharging device, a supply and demand of electric power in the airport may be balanced by supplying electric power from the battery of the electric vehicle to the electric power system. However, the Patent Document 1 does not disclose supplying power from the storage battery of the electric vehicle to the electric power system of the airport. Therefore, in the airport to which the above energy management device is applied, the electric vehicle supplying power to the electric power system may not be properly selected, and an operation of the electric vehicle may be disturbed.

A main object of the present disclosure is to allow electric power from the power storage device of the electric vehicle to be supplied to the electric power system of the facility while smoothly operating the electric vehicle that transports the cargo at least in the facility.

A power management system of the present disclosure manages an exchange of electric power between power storage devices of a plurality of electric vehicles which respectively transport a cargo at least in a facility, and a charging and discharging device connected to an electric power system of the facility. The power management system includes a vehicle management device. The vehicle management device is configured to select the electric vehicle with surplus capacity for a discharge from the power storage device based on SOC of the power storage device of each of the electric vehicles and the weight of the cargo of each of the electric vehicles when an electric power supply from at least one of the electric vehicles to the electric power system is requested. Further, the vehicle management device is configured to instruct the selected electric vehicle to discharge from the power storage device to the electric power system.

An electric vehicle of the present disclosure transports a cargo at least in a facility. The electric vehicle includes a power storage device and a controller. The power storage device exchanges electric power with a charging and discharging device connected to an electric power system of the facility. The controller is programmed to determine whether there is surplus capacity for a discharge from the power storage device based on SOC of the power storage device and a weight of the cargo when an electric power supply from the power storage device to the electric power system is requested. When there is surplus capacity for the discharge from the power storage device, the controller decreases a lower limit SOC of the power storage device, compared to a case where there is no surplus capacity for the discharge from the power storage device.

According to the power management system and the vehicle of the present disclosure, electric power from the power storage device of the electric vehicle is allowed to be supplied to the electric power system of the facility while smoothly operating the electric vehicle that transports the cargo at least in the facility.

### BRIEF DESCRIPTION OF DRAWINGS

FIG. 1 is a schematic configuration diagram illustrating a facility to which a power management system of the present disclosure is applied;

FIG. 2 is a schematic configuration diagram illustrating an electric vehicle used in the facility of FIG. 1;

FIG. 3 is a flowchart exemplifying a routine executed by a vehicle management device of the power management system of the present disclosure;

FIG. 4 is a flowchart showing one example of a routine executed in the electric vehicle of the present disclosure; and

FIG. 5 is a flowchart showing another example of a routine executed in the electric vehicle of the present disclosure.

### DESCRIPTION OF EMBODIMENTS

The following describes some aspects of the present disclosure with reference to drawings.

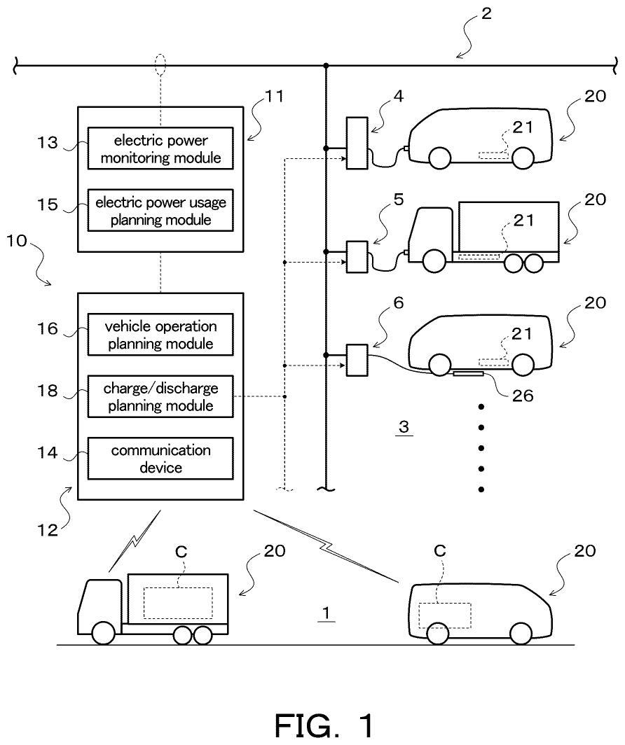

FIG. 1 is a schematic configuration diagram illustrating a facility 1 to which a power management system 10 of the present disclosure is applied. The facility 1 shown in FIG. 1 is an airport. The facility 1 includes various equipment (not shown) related to an aircraft operation and the like, an electric power system 2 that supplies AC power to each equipment, and a charging and discharging area 3 for a plurality of electric vehicles 20 that transport cargo C at the facility 1. The electric power system 2 is interconnected to multiple power supply devices such as power transmission facilities of electric power companies, renewable energy power generation devices (a solar power generation device, a wind power generation device and the like) and a cogeneration systems installed in the facility 1. The charging and discharging area 3 includes a plurality of charging and discharging devices 4, a plurality of charging and discharging devices 5, and a plurality of charging and discharging devices 6.

The charging and discharging device 4 is a DC type rapid charging and discharging device. The charging and discharging device 4 is capable of converting AC power from the electric power system 2 into DC power and supplying it to the battery (power storage device) 21 of the electric vehicle 20, as well as converting DC power from the battery 21 into AC power and supplying it to the electric power system 2. The charging and discharging device 5 is an AC type charging and discharging device. The charging and discharging device 5 is capable of transforming AC power from the electric power system 2 and supplying it to the electric vehicle 20 (battery 21), as well as transforming AC power from the electric vehicle 20 and supplying it to the electric power system 2. The charging and discharging device 6 is a non-contact charging and discharging device. The charging and discharging device 6 is also capable of transforming AC power from the electric power system 2 and supplying it to the electric vehicle 20 (battery 21), as well as transforming AC power from the electric vehicle 20 and supplying it to the electric power system 2. That is, the electric power system 2 is capable of interconnecting with the battery 21 of the electric vehicle 20 as the power supply device via the charging and discharging devices 4, 5, and 6. At least one charging and discharging device 4 and at least one charging and discharging device 5 may be arranged in charging and discharging area 3. The charging and discharging device 6 may be omitted from the charging and discharging area 3.

The electric vehicles 20 are battery electric vehicles (BEVs) or plug-in hybrid vehicles (PHEVs). The electric vehicles 20 include a truck, a van, a 1-box car, a towing tractor, a belt loader, a ramp bus, a food loader, a sewage vehicle, a water vehicle, a trash vehicle, a refueling vehicle, or the like. The electric vehicle 20 may drive outside the facility 1 as well as inside the facility 1, and may be a self-driving vehicle. The cargo C of the electric vehicle 20 includes those loaded on a dolly towed by a towing tractor.

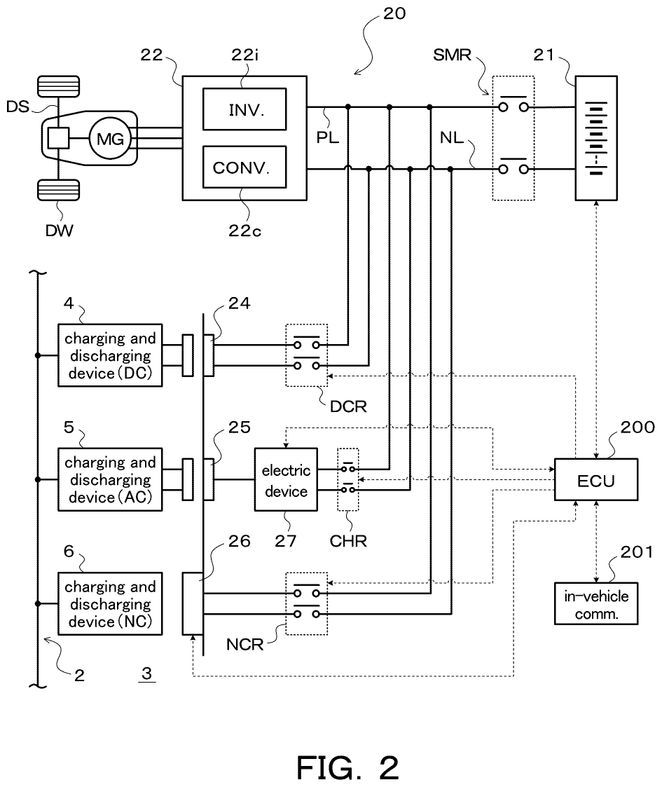

As shown in FIG. 2, the electric vehicle 20 includes, in addition to the battery 21, a system main relay SMR, a power control unit (“PCU”) 22, and a motor generator MG. Battery 21 is, for example, a lithium-ion secondary battery or a nickel-metal hydride secondary battery. A positive side power line PL is connected to a positive terminal of the battery 21 via a positive side relay of the system main relay SMR. A negative side power line NL is connected to a negative terminal of the battery 21 via a negative side relay of the system main relay SMR.

The PCU 22 is connected to the battery 21 via the positive side power line PL, the negative side power line NL, and the system main relay SMR. The PCU 22 includes an inverter (drive circuit) 221 that drives the motor generator MG, a boost converter 22c and the like. The motor generator MG is a synchronous generator motor (three-phase AC motor). A rotor of the motor generator MG is connected to drive shafts DS respectively connected to a drive wheel DW via a power transmission mechanism including a reduction gear and a differential gear. The motor generator MG is driven by electric power from the PCU 22 (battery 21) and outputs driving torque (driving force) to the drive shafts DS. Further, the motor generator MG outputs regenerative braking torque to the drive shafts DS when the electric vehicle 20 is braked.

As shown in FIG. 2, the electric vehicle 20 includes a DC receptacle 24 into which a charging and discharging connector of the charging and discharging device 4 is plugged, an AC receptacle 25 into which a charging and discharging connector of the charging and discharging device 5 is plugged, and a noncontact electric power transmitting and receiving device 26. The DC receptacle 24 is connected to a relay DCR. The relay DCR is connected to the positive side power line PL and the negative side power line NL between the system main relay SMR and the PCU 22. When the relay DCR and the system main relay SMR are closed, the DC receptacle 24 is connected to the battery 21. The AC receptacle 25 is connected to an electric device 27, which includes an AC/DC converter and a DC/DC converter. The electric device 27 is connected to the positive side power line PL and the negative side power line NL between the system main relay SMR and the PCU 22 via the relay CHR. When the relay CHR and the system main relay SMR are closed, the AC receptacle 25 is connected to the battery 21 via the electric device 27.

The noncontact electric power transmitting and receiving device 26 includes an AC/DC converter and a DC/DC converter. The noncontact electric power transmitting and receiving device 26 is fixed to a lower surface of a floor panel of the electric vehicle 20 and is connected to a relay NCR. The relay NCR is connected to the positive side power line PL and the negative side power line NL between the system main relay SMR and the PCU 22. When the relay NCR and the system main relay SMR are closed, the noncontact electric power transmitting and receiving device 26 is connected to the battery 21. The noncontact electric power transmitting and receiving device 26 is capable of receiving AC power from the charging and discharging device 6 in the charging and discharging area 3 in a noncontact manner, as well as converting power from the battery 21 to AC power and transmitting it to the charging and discharging device 6 in a noncontact manner.

Further, as shown in FIG. 2, the electric vehicle 20 includes an electronic control unit (hereinafter referred to as “ECU”) 200 that manages the battery 21 and an in-vehicle communication device 201. The ECU 200 includes a microcomputer with CPU, ROM, RAM and the like, which are not shown in FIG. 2. The ECU 200 calculates SOC of the battery 21 based on a voltage between terminals, charging and discharging current, temperature, and the like of the battery 21. The ECU 200 also controls the noncontact electric power transmitting and receiving device 26 and the charging and discharging devices 27, and also opens and closes the relays DCR, CHR, and NCR. Further, the ECU 200 calculates a weight of the cargo C based on detected values of a suspension stroke sensor (not shown) and other sensors of the electric vehicle 20. The in-vehicle communication device 201 exchanges various information with the ECU 200 and also exchanges various information with external devices via wireless data communication (packet high-speed communication).

The power management system 10 manages an exchange of power between the batteries 21 of the plurality of electric vehicles 20 and the charging and discharging devices 4, 5 or 6 respectively connected to the electric power system 2 of the facility 1. As shown in FIG. 1, the power management system 10 includes a facility management server (facility management device) 11 and a vehicle management server (vehicle management device) 12. The facility management server 11 manages electric power supply and demand in the facility 1. The vehicle management server 12 exchanges information with the facility management server 11 and manages all of the electric vehicles 20 used in the facility 1, and the charging and discharging area 3.

The facility management server 11 includes a computer with CPU, ROM, RAM, I/O devices and the like, and storage devices that store various information. In the facility management server 11, an electric power monitoring module 13 and an electric power usage planning module 15 are constructed in cooperation with hardware such as CPU, ROM, and RAM, and programs installed in advance. The electric power monitoring module 13 acquires information such as voltage and frequency of the electric power system 2, and monitors status of power fluctuations in the electric power system 2 based on the acquired information. The electric power monitoring module 13 also acquires information on status of power usage in each equipment (including the charging and discharging area 3) of the facility 1. The electric power usage planning module 15 prepares electric power usage plan for the facility 1 based on the information acquired by the electric power monitoring module 13 every predetermined time (for example, 1-2 hours), and transmits the prepared electric power usage plan to each facility in the facility 1. The electric power usage plan includes predicted electric power consumption, predicted surplus electric power, predicted shortage electric power, and predicted amount of electric power allowed to each facility during the predetermined time period.

The vehicle management server 12 includes a computer with CPU, ROM, RAM, I/O devices and the like, storage devices that store various information, and a communication device 14 that communicates with the in-vehicle communication device 201 of the electric vehicle 20. The vehicle management server 12 exchanges information with the charging and discharging devices 4, 5, and 6 in the charging and discharging area 3. Further, in the vehicle management server 12, a vehicle operation planning module 16 and a charge and discharge planning module 18 are constructed in the cooperation with hardware such as CPU, ROM, and RAM, and pre-installed programs. The vehicle operation planning module 16 prepares a vehicle operation plan for all of the electric vehicles 20 used in the facility 1 every predetermined time (for example, 1-2 hours). The charge and discharge planning module 18 prepares a charge and discharge plan for the batteries 21 of all of the electric vehicles 20 in use at the facility 1 every predetermined time (e.g., 1-2 hours). The charge and discharge plan specifies, for each of the 20 electric vehicles, whether the battery 21 needs to be charged or discharged, a target SOC for the battery 21, the charging and discharging devices 4, 5 or 6 in the charging and discharging area 3 to be connected, and the like.

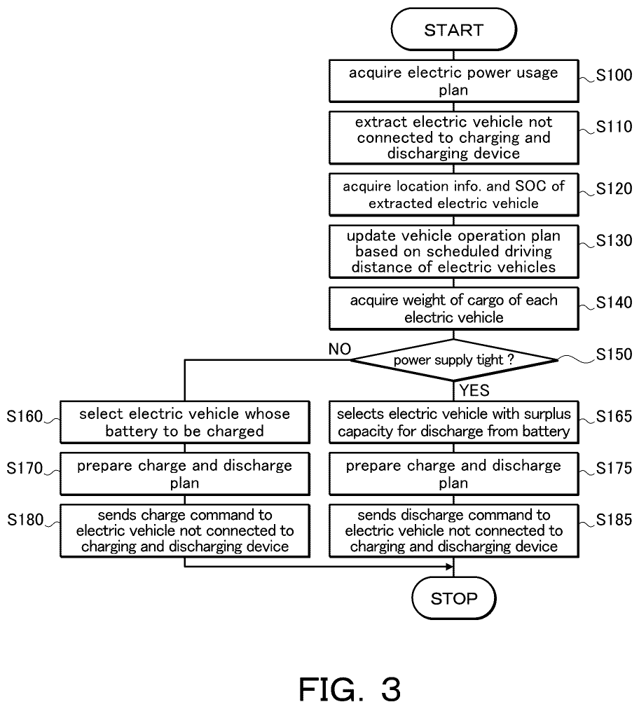

Next, procedures for preparing the vehicle operation plan and the charge and discharge plan by the vehicle management server 12 will be described with reference to FIG. 3. FIG. 3 is a flowchart showing a routine executed by the vehicle management server 12 in response to receipt of the electric power usage plan from the facility management server 11 (electric power usage planning module 15).

When a timing for execution of the routine in FIG. 3 arrives, the vehicle management server 12 acquires the electric power usage plan from the facility management server 11 (step S100). Then, the vehicle management server 12 extracts the electric vehicles 20 that are not connected to the charging and discharging device 4, 5 or 6 in the charging and discharging area 3 based on information from the charging and discharging area 3 (step S110). Further, the vehicle management server 12 acquires location information of the electric vehicles 20 extracted in step S110 and SOC of the battery 21 (step S120). In step S120, the vehicle management server 12 requests the electric vehicles 20 that are not connected to the charging and discharging device 4, 5 or 6 to send the location information and the SOC of the battery 21. In response to the request from the vehicle management server 12, the ECU 200 of the electric vehicle 20 sends its own vehicle location information acquired by GPS and the SOC of the battery 21 to the vehicle management server 12 via the in-vehicle communication device 201.

After the process of step S120, the vehicle operation planning module 16 of the vehicle management server 12 updates the vehicle operation plan based on the location information of each electric vehicle 20, the SOC of the battery 21 of each electric vehicle 20, a scheduled driving distance of each electric vehicle 20 until next vehicle operation plan update timing (the next execution timing of the routine in FIG. 3) and the like (step S130). The location information and the SOC of the battery 21 of the electric vehicle 20 connected to the charging and discharging device 4, 5 or 6 are sent from the charging and discharging device 4, 5 or 6 to the vehicle management server 12. Further, the vehicle management server 12 acquires a weight of the cargo C of each electric vehicle 20 (step S140). The weight of the cargo C of the electric vehicle 20 parked in the charging and discharging area 3 is acquired based on a detection value of a vehicle weight meter (not shown) installed in a parking space in the charging and discharging area 3. The weight of the cargo C of the electric vehicle 20 that is not connected to the charging and discharging device 4, 5 or 6 in the charging and discharging area 3 is calculated by the ECU 200 of the electric vehicle 20 and sent to the vehicle management server 12 from the in-vehicle communication device 201.

The vehicle management server 12 then determines whether the electric power supply in the electric power system 2 is tight or not based on the electric power usage plan from the facility management server 11 (step S150). When the electric power supply in the electric power system 2 is not tight (step S150: NO), the charge and discharge planning module 18 of the vehicle management server 12 selects the electric vehicles 20 whose batteries 21 is to be charged based on the amount of electric power allowed to the charging and discharging area 3 in the electric power usage plan and the SOC of the battery 21 of each electric vehicle 20 (step S160). Further, the charge and discharge planning module 18 prepares the charge and discharge plan (in this case, a charge plan) for the electric vehicles 20 based on a selection result of step S160 and the weight of the cargo C of each electric vehicle 20 acquired in step S140 (step S170).

In step S170, the charge and discharge planning module 18, for example, increases the target SOC of the battery 21 of the electric vehicle 20 whose cargo C is heavier than the predetermined relatively large first weight, compared to the battery 21 of the electric vehicle 20 whose cargo C is lighter than the first weight. As a result, when the batteries 21 of the plurality of electric vehicles 20 are charged by electric power from the electric power system 2 according to the charge and discharge plan, the target SOC of the batteries 21 of the electric vehicles 20 with a heavier cargo C is higher than that of the batteries 21 of the electric vehicles 20 with a lighter cargo C. The vehicle management server 12 then sends a charge command based on the charge and discharge plan to the electric vehicle 20 whose battery 21 is to be charged, which is not connected to the charging and discharging device 4, 5 or 6 in the charging and discharging area 3 (step S180), and terminates the routine in FIG. 3.

The charge command from the vehicle management server 12 includes the target SOC of the battery 21, and the charging and discharging device 4, 5 or 6 in the charging and discharging area 3 to which the electric vehicle 20 is to be connected. The electric vehicle 20, whose battery 21 is to be charged, is driven by the driver or automatically to the designated parking space in the charging and discharging area 3 in response to receipt of the charge command. The vehicle management server 12 also sends the charge and discharge plan prepared in step S170 to the charging and discharging devices 4, 5 and 6 in the charging and discharging area 3. The charging and discharging devices 4, 5 and 6 charge the battery 21 of the corresponding electric vehicle 20 with electric power from the electric power system 2 according to the charge and discharge plan from the vehicle management server 12.

On the other hand, when the electric power supply in the electric power system 2 is tight and the electric power supply from at least one electric vehicle 20 to the electric power system 2 is required (step S150: YES), the charge and discharge planning module 18 of the vehicle management server 12 selects the electric vehicles 20 with surplus capacity for a discharge from the battery 21 based on the SOC of the battery 21 of each electric vehicle 20, and the weight of the cargo C of each electric vehicle 20 acquired in step S140 (step S165). In step S165, the charge and discharge planning module 18 selects, for example, the electric vehicle 20 in which the SOC of the battery 21 is equal to or more that a predetermined relatively large allowable discharge threshold and the weight of the cargo C is less than a predetermined relatively small second weight.

Further, the charge and discharge planning module 18 prepares the charge and discharge plan (in this case, a discharge plan) for the electric vehicles 20 based on the selection result in step S165 (step S175). In step S175, the charge and discharge planning module 18 sets a predetermined value S0, which is lower than a value S1 of a predetermined lower limit SOC of the battery 21 of each electric vehicle 20, as the target SOC of the electric vehicle 20 with surplus capacity for the discharge from the battery 21, which is selected in step S165. The vehicle management server 12 then sends a discharge command based on the charge and discharge plan to the electric vehicle 20 with surplus capacity for the discharge from the battery 21, that is not connected to the charging and discharging device 4, 5 or 6 in the charging and discharging area 3 (step S185), and terminates the routine in FIG. 3.

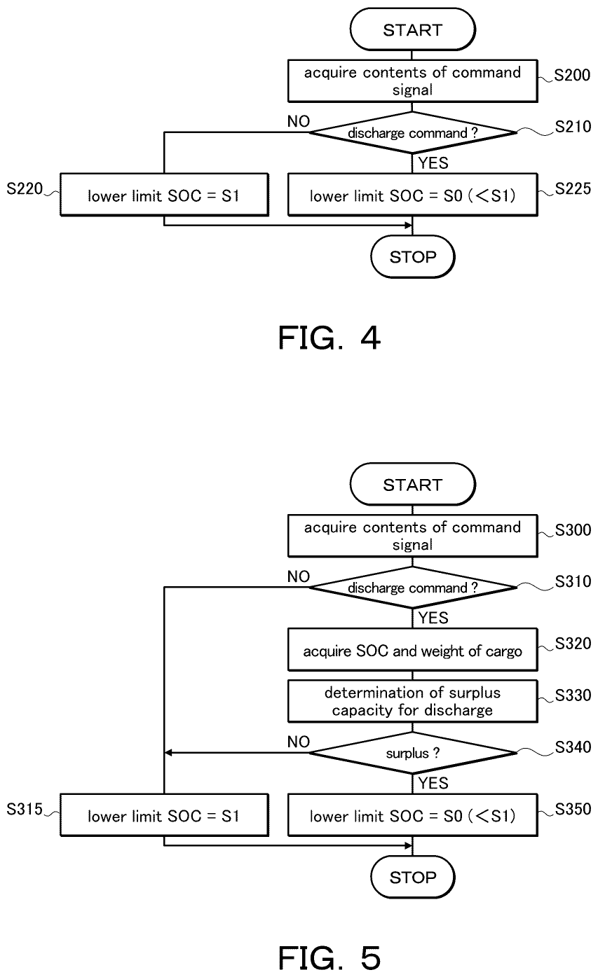

The discharge command from the vehicle management server 12 includes the target SOC of the battery 21, and the charging and discharging device 4, 5 or 6 in the charging and discharging area 3 to which the electric vehicle 20 is to be connected. In this embodiment, the ECU 200 of the electric vehicle 20 executes a routine shown in FIG. 4 when a command signal from the vehicle management server 12 is received by the in-vehicle communication device 201. The ECU 200 acquires contents of the command signal from the vehicle management server and determines whether the command signal is a discharge command or not (step S210). When the command signal from the vehicle management server 12 is a charge command (step S210: NO), the ECU 200 sets (maintains) the above value S1 to the lower limit SOC of the battery 21 (step S220) and terminates the routine in FIG. 4. When the command signal from the vehicle management server 12 is the discharge command (step S210: YES), the ECU 200 sets (changes) the above value S0 (<S1), which is equal to the target SOC, to the lower limit SOC of the battery 21 (step S225) and terminates the routine in FIG. 4. That is, the vehicle management server 12 decreases the lower limit SOC of the electric vehicle 20 with surplus capacity for the discharge from the battery 21 compared to the electric vehicle 20 with no surplus capacity for the discharge from the battery 21.

The electric vehicle 20 whose battery 21 is to be discharged is driven by the driver or automatically to the designated parking space in the charging and discharging area 3 in response to the receipt of the discharge command. The vehicle management server 12 also sends the charge and discharge plan prepared in step S175 to the charging and discharging devices 4, 5, and 6 in the charging and discharging area 3. The charging and discharging devices 4, 5 and 6 discharge the battery 21 of the corresponding electric vehicle 20 according to the charge and discharge plan from the vehicle management server 12, and supply power from the battery 21 to the electric power system 2. The operation of the charging and discharging device 4, 5 or 6 may be stopped when the SOC of the battery 21 reaches the target SOC(=S0) due to the discharge from the battery 21 to the electric power system 2. The relay DCR, CHR or NCR may be opened by the ECU 200 of the electric vehicle 20 when the SOC of the battery 21 reaches the target SOC(=S0).

As described above, the power management system 10 includes the vehicle management server 12 that manages the exchange of electric power between the batteries 21 of the plurality of electric vehicles 20 that respectively transport the cargo C in at least facility 1 and the charging and discharging devices 4, 5, and 6 connected to the electric power system 2 of the facility 1. When the electric power supply from at least one electric vehicle 20 to the electric power system 2 is requested (step S150: YES), the vehicle management server 12 selects the electric vehicle 20 with surplus capacity for the discharge from the battery 21 based on the SOC of the battery 21 of each electric vehicle 20 and the weight of the cargo C of each electric vehicle 20 (Step S165). That is, the vehicle management server 12 properly selects the electric vehicle 20 capable of supplying electric power to the electric power system 2 of the facility 1 in consideration the weight of the cargo C in addition to the SOC of the battery 21. This prevents electric power from being supplied to the electric power system 2 from the electric vehicle 20 without surplus capacity for the discharge from the battery 21, thereby preventing the SOC of the battery 21 of the electric vehicle 20 from becoming insufficient. Further, the vehicle management server 12 instructs the selected electric vehicle 20 to discharge electric power from the battery 21 to the electric power system 2 (step S185). This allows the electric vehicles 20 with surplus capacity for the discharge from the battery 21 to be connected to the charging and discharging device 4, 5 or 6. As a result, the power management system 10 allows electric power to be supplied from the batteries 21 of the electric vehicles 20 to the electric power system 2 of the facility 1 while smoothly operating the electric vehicles 20 that transport the cargo C.

The vehicle management server 12 decreases the lower limit SOC of the electric vehicle 20 with surplus capacity for the discharge from the battery 21 compared to the electric vehicle 20 without surplus capacity for the discharge from the battery 21 (steps S175, S185). This allows more electric power to be supplied to the electric power system 2 from the electric vehicles 20 with surplus capacity for the discharge of the battery 21.

The power management system 10 includes the facility management server 11 that monitors the electric power supply and demand status of the electric power system 2 and prepares the electric power usage plan for the facility 1. The vehicle management server 12 prepares the vehicle operation plan for the plurality of electric vehicles 20 based on the electric power usage plan prepared by the facility management server 11 (step S130) and determines whether or not the electric power supply from at least one electric vehicle 20 to the electric power system 2 is requested based on the electric power usage plan (step S150). This enables the electric power supply and demand in the facility 1 to be satisfactorily balanced.

When the batteries 21 of the plurality of electric vehicles 20 are charged by electric power from the electric power system 2 (step S150: NO), the vehicle management server 12 increases the target SOC of the batteries 21 of the electric vehicles 20 with heavier cargo C than that of the batteries 21 of the electric vehicles 20 with lighter cargo C (step S170). This allows the batteries 21 of the plurality of electric vehicles 20 to be properly charged, thereby enabling the electric vehicles 20 to be operated smoothly.

The power management system 10 may be applied to facilities other than the airport. For example, the power management system 10 may be applied to factories, distribution facilities such as distribution centers, and large-scale commercial facilities.

Instead of the vehicle management server 12, the ECU 200 of the electric vehicle 20 may determine whether there is surplus capacity for the discharge of the battery 21 of the electric vehicle 20. FIG. 5 is a flowchart showing an example of a routine that may be executed by the ECU 200 in response to a receipt of a command signal from the vehicle management server 12 by the in-vehicle communication device 201. When the command signal from the vehicle management server 12 is received by the in-vehicle communication device 201, the ECU 200 acquires the contents of the command signal from the vehicle management server 12 (step S300) and determines whether or not the command signal is the discharge command (step S310). When the command signal from the vehicle management server 12 is the charge command (step S310: NO), the ECU 200 sets (maintains) the above value S1 to the lower limit SOC of the battery 21 (step S315) and terminates the routine in FIG. 5.

When the command signal from the vehicle management server 12 is the discharge command and the discharge from the battery 21 to the electric power system 2 is requested (step S310: YES), the ECU 200 acquires the SOC of the battery 21 and the weight of the cargo C separately calculated (step S320) and determines whether there is surplus capacity for the discharge from the battery 21 (step S330). In step S330, the ECU 200 determines, for example, whether the SOC of the battery 21 is equal to or more than the predetermined relatively large discharge allowance threshold and whether the weight of the cargo C is less than the predetermined relatively small second weight. When the SOC of the battery 21 is less than the allowable discharge threshold or the weight of the cargo C is equal to or more than the second weight and there is no surplus capacity for the discharge from the battery 21 (step S340: NO), the ECU 200 sets (maintains) the above value S1 as the lower limit SOC of the battery 21 (step S315) and terminates the routine in FIG. 5. On the other hand, when the SOC of the battery 21 is equal to or more than the allowable discharge threshold and the weight of the cargo C is less than the second weight and there is surplus capacity for the discharge from the battery 21 (step S340: YES), the ECU 200 sets the above value S0, which is lower than the value S1, as the lower limit SOC of the battery 21 (step S350), and terminates the routine in FIG. 5.

The ECU 200 executing the routine in FIG. 5 properly determines whether or not electric power is allowed to be supplied from the battery 21 to the electric power system 2 of the facility 1 in consideration with the weight of the cargo C in addition to the SOC of the battery 21. When there is surplus capacity for the discharge from the battery 21 (step S340: YES), the ECU 200 decreases the lower limit SOC of the battery 21 (step S350) compared to a case where there is no surplus capacity for the discharge from the battery 21 (step S340: NO). This allows more power to be supplied to the electric power system 2 when there is surplus capacity for the discharge of the battery 21. Further, the ECU 200 suppresses at least more electric power than necessary to be supplied from the battery 21 to the electric power system 2 when there is no surplus capacity for the discharge from the battery 21, thereby preventing the SOC of the battery 21 of the electric vehicle 20 from becoming insufficient. As a result, electric power from the battery 21 of the electric vehicle 20 is allowed to be supplied to the electric power system 2 of the facility 1 while smoothly operating the electric vehicles 20 that transport the cargo C.

As has been described above, the power management system (10) of the present disclosure manages the exchange of electric power between the power storage devices (21) of the plurality of electric vehicles (20) which respectively transport a cargo (C) at least in the facility (1), and the charging and discharging device (4, 5, 6) connected to the electric power system (2) of the facility (1). The power management system (10) includes the vehicle management device (12). The vehicle management device (12) is configured to select the electric vehicle (20) with surplus capacity for the discharge from the power storage device (21) based on the SOC of the power storage device (21) of each of the electric vehicles (20) and the weight of the cargo (C) of each of the electric vehicles (20) (S165) when the electric power supply from at least one of the electric vehicles (20) to the electric power system (2) is requested (S150: YES). That is, the vehicle management device (12) properly selects the electric vehicle (20) capable of supplying electric power to the electric power system (2) of the facility (1) in consideration of the weight of the cargo (C) in addition to the SOC of the power storage device (21). This prevents electric power from being supplied to the electric power system (2) from the electric vehicle (20) without surplus capacity for the discharge from the power storage device (21), thereby preventing the SOC of the power storage device (21) of the electric vehicle (20) from becoming insufficient. Further, the vehicle management device (12) is configured to instruct the selected electric vehicle (20) to discharge from the power storage device (21) to the electric power system (2) (S185). This allows the electric vehicles (20) with surplus capacity for the discharge from the power storage device (21) to be connected to the charging and discharging device (4, 5, 6). As a result, the power management system (10) of the present disclosure allows electric power from the power storage device (21) of the electric vehicle (20) to be supplied to the electric power system (2) of the facility (1) while smoothly operating the plurality of electric vehicles (20) that transport the cargo (C) at least in the facility (1).

The vehicle management system (12) may be configured to decrease the lower limit SOC of the electric vehicle (20) with surplus capacity for the discharge from the power storage device (21) compared to the electric vehicle (20) without surplus capacity for the discharge from the power storage device (21) (S175, S185). This allows more electric power to be supplied to the electric power system (2) from the electric vehicle (20) with surplus capacity for the discharge of the power storage device (21).

The power management system (10) may include the facility management device (11) that monitors the electric power supply and demand status of the electric power system (2) and prepares the electric power usage plan for the facility (1). The vehicle management device (12) may be configured to prepare the operation plan for the plurality of electric vehicles (20) based on the electric power usage plan prepared by the facility management device (11) (S130), and determine whether or not the electric power supply from at least one of the electric vehicles (20) to the electric power system (2) is requested based on the electric power usage plan (S150). This enables the electric power supply and demand in the facility (1) to be satisfactorily balanced.

The vehicle management device (12) may be configured to increases a target SOC of the power storage device (21) of the electric vehicle (20) with the heavier cargo (C) compared to the power storage device (21) of the electric vehicle (20) with the lighter cargo (C) (S175) when the power storage devices (21) of the plurality of electric vehicles (20) are charged by electric power from the electric power system (2) (S150: NO). This allows the power storage devices (21) of the plurality of electric vehicles (20) to be properly charged, thereby enabling the electric vehicles (20) to be operated smoothly.

The electric vehicle (20) of the present disclosure transports the cargo (C) at least in the facility (1). The electric vehicle (20) includes the power storage device (21) and the controller (200). The power storage device (21) exchanges electric power with the charging and discharging device (4, 5, 6) connected to the electric power system (2) of the facility (1). The controller (200) is programmed to determine whether there is surplus capacity for the discharge from the power storage device (21) based on the SOC of the power storage device (21) and the weight of the cargo (C) (S330, S340) when the electric power supply from the power storage device (21) to the electric power system (2) is requested (S310: YES). That is, the controller (200) properly determines whether or not electric power is allowed to be supplied from the power storage device (21) to the electric power system (2) of the facility (1) in consideration of the weight of the cargo (C) in addition to the SOC of the power storage device (21). When there is surplus capacity for the discharge from the power storage device (21) (S340: YES), the controller (200) decreases the lower limit SOC of the power storage device (21) (S350), compared to a case where there is no surplus capacity for the discharge from the power storage device (21) (S340: NO). This enables more electric power to be supplied to the electric power system (2) from the electric vehicle (20) with surplus capacity for the discharge of the power storage device (21). Further, the controller (200) suppresses at least more electric power than necessary to be supplied from the power storage device (21) to the electric power system (2) when there is no surplus capacity for the discharge from the battery 21, thereby preventing the SOC of the power storage device (21) of the electric vehicle (20) from becoming insufficient. As a result, electric power from the power storage device (21) of the electric vehicle (20) is allowed to be supplied to the electric power system (2) of the facility (1) while smoothly operating the electric vehicle (20) that transports the cargo (C) at least in the facility (1).

The disclosure is not limited to the above embodiments in any sense but may be changed, altered or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The technique of the present disclosure is applicable to, for example, facilities where the cargo are transported by the plurality of electric vehicles, and the manufacturing industry for the electric vehicle.

1. A power management system that manages an exchange of electric power between power storage devices of a plurality of electric vehicles which respectively transport a cargo at least in a facility, and a charging and discharging device connected to an electric power system of the facility, the power management system comprising:
a vehicle management device configured to
select the electric vehicle with surplus capacity for a discharge from the power storage device based on SOC of the power storage device of each of the electric vehicles and the weight of the cargo of each of the electric vehicles when an electric power supply from at least one of the electric vehicles to the electric power system is requested, and
instruct the selected electric vehicle to discharge from the power storage device to the electric power system.

2. The power management system according to claim 1,
wherein the vehicle management device is configured to decrease a lower limit SOC of the electric vehicle with surplus capacity for the discharge from the power storage device compared to the electric vehicle without surplus capacity for the discharge from the power storage device.

3. The power management system according to claim 1, further comprising:
a facility management device that monitors the electric power supply and demand status of the electric power system and prepares an electric power usage plan for the facility;
wherein the vehicle management device is configured to prepare an operation plan for the plurality of electric vehicles based on the electric power usage plan prepared by the facility management device, and determine whether or not the electric power supply from at least one of the electric vehicles to the electric power system is requested based on the electric power usage plan.

4. The power management system according to claim 1,
wherein the vehicle management device is configured to increases a target SOC of the power storage device of the electric vehicle with a heavier cargo compared to the power storage device of the electric vehicle with a lighter cargo when the power storage devices of the plurality of electric vehicles are charged by electric power from the electric power system.

5. An electric vehicle that transports a cargo at least in a facility, the electric vehicle comprising:
a power storage device that exchanges electric power with a charging and discharging device connected to an electric power system of the facility; and
a controller programmed to
determine whether there is surplus capacity for a discharge from the power storage device based on SOC of the power storage device and a weight of the cargo when an electric power supply from the power storage device to the electric power system is requested, and
decrease a lower limit SOC of the power storage device when there is surplus capacity for the discharge from the power storage device, compared to a case where there is no surplus capacity for the discharge from the power storage device.
